(19) United States
(12) Patent Application Publication
(10) Pub. No.: US 2024/0063731 A1
(43) Pub. Date: Feb. 22, 2024

(54) PROPULSION SYSTEM, INERTIA ATTENUATOR AND FORCE FIELD GENERATOR

(71) Applicant: Alexandre TIAGO BAPTISTA DE ALVES MARTINS, Brasilia (BR)

(72) Inventor: Alexandre TIAGO BAPTISTA DE ALVES MARTINS, Brasilia (BR)

(21) Appl. No.: 18/225,066

(22) Filed: Jul. 21, 2023

Related U.S. Application Data
(63) Continuation-in-part of application No. PCT/BR2022/050014, filed on Jan. 18, 2022.

(30) Foreign Application Priority Data
Jan. 22, 2021 (BR) 102021001266-8

(51) Int. Cl. H02N 11/00

(52) U.S. Cl. CPC H02N 11/006

(57) ABSTRACT

The present invention relates to a new form of air, land, underwater or space propulsion achieved by the use of suitable electromagnetic interactions. By using capacitors formed by symmetric or asymmetric conductors (1) and (2), surrounded by a dielectric (3), subjected to asymmetric voltage pulses or with asymmetric electric field derivative we obtain directional propulsion forces. This is possible due to a new electromagnetic propulsion mechanism that uses conservation of total momentum where the sum of the mechanical momentum with the electric field momentum should always be conserved resulting in a constant and zero total sum of the two components, where the change in electric field momentum will generate a corresponding change in the mechanical momentum of the capacitor thus generating propulsion forces where the inertia forces are attenuated and can generate force fields.

### CROSS REFERENCE TO RELATED APPLICATIONS

This application is a continuation in part of PCT Patent Application No. PCT/BR2022/050014 having International filing date of Jan. 18, 2022, which claims the benefit of priority of Brazilian Patent Application No. BR 102021001266-8, filed Jan. 22, 2021, the contents of which are all incorporated herein by reference in their entirety.

### SUMMARY OF THE INVENTION

The present invention relates to a new form of air, land, submarine or space propulsion, with attenuation of inertial forces and generation of force fields, achieved by the use of suitable electromagnetic interactions that will be explained below.

Recent experiments with symmetrical and asymmetrical capacitors immersed inside vacuum chambers or subjected to the atmosphere but surrounded by a protective dielectric have shown the existence of a new type of electromagnetic propulsion. This is possible due to the conservation of total momentum where the sum of the mechanical momentum and the electric field momentum should always be conserved resulting in a constant and zero total sum of the two components, where the change in electric field momentum will generate a corresponding change in the mechanical momentum of the capacitor thus generating propulsion forces.

As prior art of capacitor propulsion we refer to two patents developed by Thomas Townsend Brown. In the first, capacitors are used that are subjected to static voltages without variations or oscillations (UK Patent 300,311, 1927), where propulsion would always be generated in the direction of the positive pole of the capacitor. In the second patent (U.S. Pat. No. 3,187,206, 1965) it is described how asymmetrical capacitors with the conductors subjected to the atmosphere and fed by static or alternating sinusoidal voltage signals generate propulsion in the direction opposite to the spatial asymmetry of the electric field or asymmetry of the dielectric. The current state of the art regarding inertialess propulsion is given by U.S. Pat. No. 10,144,532 (2018) by Salvatore Cezar Pais. This patent describes a propulsion system that uses microwaves to vibrate an electrically charged metal surface.

The propulsion systems proposed in the present patent using capacitors represent a significant improvement over Townsend Brown's prior art using simpler systems than those described by Salvatore Pais. We will move on to describing how the propulsion, inertial attenuation, and force field generation systems of the present patent work.

When the atoms of a dielectric material are subjected to an external electric field, they acquire an electric potential energy density Uₚₑ given by:

Uₚₑ=−P·E[J/m³] (1)

Where E is the applied external electric field and P is the atomic polarization vector of a linear dielectric:

P=ε₀χₑE=ε(εᵣ−1)E (2)

With susceptibility χₑ, vacuum permittivity ε₀ and relative electrical permittivity εᵣ. The electric energy density U_{E}, taking into account the polarization effects of matter is:

$${U}_{E} = \frac{E \cdot D}{2} [ \frac{J}{{m}^{3}} ] \qquad ( 3 )$$

Which can be rewritten as:

$${U}_{E} = \frac{E \cdot ( {ε}_{0} E + P )}{2} = \frac{1}{2} [ {E}_{0} E \cdot E + E \cdot P ] [ \frac{J}{{m}^{3}} ] \qquad ( 4 )$$

This equation represents the sum of the electric energy densities in vacuum and in the interior of matter. The time variation of the energy density ∂U_{E}/∂t will be:

$$\frac{\partial {U}_{E}}{\partial t} = \frac{1}{2} \frac{\partial }{\partial t} [ {ε}_{0} E \cdot E + E \cdot P ] = {ε}_{0} E \cdot \frac{\partial E}{\partial t} + E \cdot \frac{\partial P}{\partial t} [ \frac{J}{{m}^{3}} \frac{1}{s} ] \qquad ( 5 )$$

The relationship between linear momentum p_{fields} and energy u_{fields} for electromagnetic fields is given by:

$${p}_{fields} = \frac{{u}_{fields}}{c} [ kg \cdot m \cdot {s}^{- 1} ] \qquad ( 6 )$$

Where c is the propagation speed of electromagnetic fields or waves. The last equation for the linear momentum of electromagnetic fields uses the equivalence between energy and matter given initially by Einstein. Full conservation of momentum between fields (p_{fields}) and matter (pₘₐₜₜₑᵣ) requires that:

$${p}_{matter} + {p}_{fields} = 0 ⇒ {p}_{mattr} = - {p}_{fields} = - \frac{1}{c} [ kg \cdot m \cdot {s}^{- 1} ] \qquad ( 7 )$$

By Newton's laws, the force is proportional to the temporal variation of the linear momentum, providing the following equation for the force density:

$${f}_{matter} = \frac{d {P}_{m a t t e r}}{d t} = - \frac{d {P}_{fields}}{dt} = - \frac{1}{c} \frac{d {U}_{fields}}{dt} [ \frac{N}{{m}^{3}} ] \qquad ( 8 )$$

Where fₘₐₜₜₑᵣ is the force density developed in matter, Pₘₐₜₜₑᵣ is the linear momentum density of matter, P_{fields} is the linear momentum density of fields, and U_{fields} is the energy density of fields. We take the approximation of holding the speed of light constant. Equation (8) represents the total balance between force densities that must exist due to the conservation of the total linear momentum between the considered matter and the fields, that is:

$$\frac{{dP}_{m a t t e r}}{dt} + \frac{{dP}_{fields}}{dt} = 0 [ \frac{N}{{m}^{3}} ] ⇒ \frac{d {P}_{m a t t e r}}{d t} + \frac{1}{c} \frac{d {U}_{fields}}{dt} = 0 [ \frac{N}{{m}^{3}} ] \qquad ( 9 )$$

For electric fields applied to capacitors, using Equations (1) and (4), the linear momentum density of the electric field P_{E} in the capacitor can be written as:

$${P}_{E} = \frac{{U}_{E}}{c} = - \frac{E \cdot D}{2 c} = - \frac{{ε}_{0}}{2 c} E \cdot E - \frac{{ε}_{0} ( {ε}_{r} - 1 )}{2 c} E \cdot E \qquad ( 10 )$$

Where we use the definition of the polarization vector as given in Equation (2), and also that the interaction potential energy is negative for dielectrics subjected to electric fields, as shown in Equation (1). This negative moment means that the electric field moment is directed in the opposite direction to the applied electric field vector, as also confirmed by experimental observations. From Equations (8) and (10), the electrical displacement force becomes:

$${f}_{matter} = \frac{d {P}_{matter}}{dt} = - \frac{d {P}_{E}}{dt} = \frac{{ε}_{0}}{c} E \cdot \frac{\partial E}{\partial t} + \frac{E}{c} \cdot \frac{\partial P}{\partial t} = \frac{{ε}_{0}}{c} E \cdot \frac{\partial E}{\partial t} + \frac{E}{c} \cdot {J}_{P} [ \frac{N}{{m}^{3}} ] \qquad ( 11 )$$

Where Jₚ is the displacement polarization current density:

$${J}_{p} = ( {ε}_{r} - 1 ) {ε}_{0} \frac{\partial E}{\partial t} = \frac{\partial P}{\partial t} \qquad ( 12 )$$

Considering the volume dielectric Vₒₗ between opposite poles of the capacitor, the force Fₘₐₜₜₑᵣ developed by each asymmetric pulse will be given by:

$${F}_{m a t t e r} = {V}_{o l} \sqrt{{ε}_{r} {μ}_{r}} ( \frac{{ε}_{0}}{c} E \cdot \frac{\partial E}{\partial t} + \frac{E}{c} \cdot \frac{\partial P}{\partial t} ) [ N ] \qquad ( 13 )$$

Where we add the term \sqrt{εᵣμᵣ} due to the change in the speed of light inside the dielectric. The variable μᵣ represents the relative magnetic permeability of the material placed between opposite poles of the capacitor. Equation (13) also includes forces related to the variation of the Polarization P (Equation (2)) of the dielectric material 3 used, that is, it includes variations in time of two different variables: both the applied electric field E and the relative electric permittivity εᵣ of the used dielectric 3. Using Equation (2) in Equation (13), we can also write that:

$$\frac{E}{c} \cdot \frac{\partial P}{\partial t} = {E}_{0} \frac{E}{c} \cdot \frac{\partial [ ( {ε}_{r} - 1 ) E ]}{\partial t} .$$

Therefore, in the final calculation of the force in Equation (13), we will have to consider the time-changing effects of both the electric field E and the relative electric permittivity εᵣ. In this way the advantages of using dielectric materials 3 where the relative electric permittivity varies in time in synchrony with the applied electric field (nonlinear dielectrics) becomes clear.

The transient mechanical forces developed by Equation (13), commonly referred to as impulse forces (occurring in short time instants) can be described by the following equation: I=∫F·dt, where I is the impulse (N·s), F is the force (N), and dt is the time (s) of actuation of the F force. Additionally, the impulse has the following form: I=Δp=(mv_{f}−mvᵢ)+(vm_{f}−vmᵢ)=m(v_{f}—vᵢ)+v(m_{f}−mᵢ), where p is the mechanical momentum, m is the mass, v_{f} is the final velocity, vᵢ is the initial velocity, m_{f} is the final mass, and mᵢ is the initial mass. Conservation of linear mechanical momentum tells us that if an object loses mass in a given direction a force will be generated that changes its velocity v_{f} in the opposite direction, gaining the object mechanical momentum in the process.

In a graph of this impulsive force as a function of time we find that the impulse of this force will be given by the integral of the area under the curve of the impulsive force between the initial and final time instants. If we have more than one impulse per second, the total impulse will be the sum of the surface area or integral under each force curve as a function of time. This necessarily implies that the total force will be directly proportional to the number of pulses per second.

In simple mathematical terms suppose that the capacitor generates an average impulsive force F₁, according to Equation (13), during the time interval t₁, so that the Impulse I₁ and corresponding change in linear momentum Δp₁ are given by: I₁=Δp₁=F₁·t₁. This approximation is valid if we consider that F₁ is the average force generated by a single force impulse. In this way, the force generated will be given by:

$${F}_{1} = \frac{Δ {p}_{1}}{{t}_{1}} = \frac{{I}_{1}}{{t}_{1}} .$$

Let us now consider that three asymmetric pulses of equal characteristics to the initial example are applied in succession over the interval of one second. In this case the total impulse I_{T} and corresponding change in total linear momentum Δp_{T} will be given by: I_{T}=Δp_{T}=F₁·t₁+F₁·t₁+F₁·t₁=3F₁·t₁, i.e., by applying three asymmetric pulses in less than one second we can triple the total impulse generated, as well as triple the total change in linear momentum, propelling the capacitor to a final velocity that is three times the final velocity achieved using a single asymmetric pulse. Continuing the development of the last equation and considering that the total force F_{T} developed is given by F_{T}=3F₁, we obtain:

$${F}_{T} = 3 {F}_{1} = \frac{{I}_{T}}{{t}_{1}} = \frac{Δ {p}_{T}}{{t}_{1}} ,$$

that is, the total force felt by the object due to the application of three equal force pulses in less than one second generates a total force three times the force of a single pulse.

In this way, the total force resulting from the repetitive application of several impulsive forces such as that of Equation (13) in a short period of time generates a sum of the applied forces. Illustratively, if a single asymmetrical voltage pulse (decay of −40 kV in 20 ns) generates a force of 2 mN, then if we apply 10⁷ asymmetrical pulses per second, the total force generated will be 20 kN. Since the current state of the technology allows the application of pulses above 100 kV with decays below ns at frequencies above Ghz the applications of propulsion and protective shielding are apparent. In this way we can generate forces of varying total magnitude using the same physical system with a capacitor or system of capacitors. This increase in total force in direct proportion to the number of pulses applied per second was observed experimentally.

The second term in Equation (13) represents the time version of Kelvin's electric gradient force equation f_{KE}, given by:

f_{KE}=P·∇E[N/m³] (14)

Where dielectrics are attracted in the direction of the gradient of applied external electric fields. Using the equation for the propagation of electric fields in space:

$${∇}^{2} E = {ε}_{0} {μ}_{0} \frac{{\partial }^{2} E}{\partial {t}^{2}} = \frac{1}{{c}^{2}} \frac{{\partial }^{2} E}{\partial {t}^{2}} \qquad ( 15 )$$

And if we square root this last equation, we get:

$$∇ E = \pm \frac{1}{c} \frac{\partial E}{\partial t} \qquad ( 16 )$$

Which gives us the spatial gradient of the electric field in terms of the temporal variation of the field and its velocity. By substituting Equation (16) into Equation (14), we recover a simplified version of the electric displacement force density f_{DE}, as given by the second term in Equation (13):

$${f}_{DE} = \frac{P}{c} \cdot \frac{\partial E}{\partial t} = {ε}_{0} ( {ε}_{r} - 1 ) \frac{E}{c} \cdot \frac{\partial E}{\partial t} [ N / {m}^{3} ] \qquad ( 17 )$$

This equation is simply a time variation (never before developed in these terms) of a long known equation, where forces are developed in dielectrics due to the spatial gradient of the electric field generated in our case by the asymmetric time variation of electric fields.

This result is further confirmation of the momentum associated with the electric field in the direction opposite to the electric vector, confirming our initial derivation, Equation (13), in terms of the conservation of field energy and total conservation of the sum of the mechanical and field moments.

Equations (11) and (13), denote an electrical displacement and polarization force acting on capacitors, which is completely electrical in origin. However, when we adopt the perspective given by the conservation of total momentum we see that this force is generated by interaction with the momentum of space-time itself, which we consider to be equivalent to the momentum of the electric field. From this perspective, this force could also be called “space bending” force, due to the direct interaction with space-time and its deformation, i.e. change in its momentum. Later on, we will clarify this link more clearly.

If the initial and final electric field derivatives are symmetric, then no force will be generated. Equation (13) only develops directional forces when the derivative of the electric field is asymmetric. Equation (13) is unique because it is directly proportional to E·∂E/∂t, not requiring time integration as done for Lorentz forces and others that are initially formulated in steady state.

A major advantage of the electric displacement, or polarization, or “space bending” force is that the shorter the applied pulse, the stronger the force generated, due to the fact that it is a time-dependent force where the momentary gradient of the electric field propagated in the dielectric increases with the speed of the pulse. Thus, the propagation of a single (E·∂E/∂t asymmetric) pulse of longitudinal electric field will directly generate the force given by Equation (13).

Considering a capacitor formed by conductors 1 and 2, separated or surrounded by dielectric 3, discharged initially with zero mechanical and field momentum, and if we charge it, then it will gain electromagnetic momentum in the direction opposite to the electric field vector E, i.e., directed from the ground/negative to the positive electrode (FIG. 1.A). During the charging process of the capacitor, it will gain a mechanical linear momentum opposite to the applied field linear momentum (so that the total sum of the momentum and its variation is zero), with direction from the positive electrode to the ground/negative electrode, generating a mechanical force on the capacitor proportional to the time variation of the electric field momentum as it charges (FIG. 1.B).

Let us now consider a capacitor that is already electrically charged and has linear field momentum (FIG. 1.A), and zero mechanical momentum. If now the capacitor is discharged then the electromagnetic moment decreases to zero and the capacitor acquires the momentum lost by the field, gaining mechanical momentum in the same direction as the electric field momentum vector (FIG. 1.C). This process again reflects the conservation of momentum by equalizing the lost field momentum to the gained mechanical momentum of the initial momentum that was present in the field. In this way, we have conservation of total linear momentum by the dynamic exchange of linear momentum between physical matter and the fields, generating mechanical forces on the capacitor proportional to the rate of change of field momentum. If we exchange the solid dielectric for air or vacuum equivalent forces given by Equation (13) will act.

Using properly constructed asymmetric voltage pulses (with asymmetric V·∂V/∂t or E·∂E/∂t) applied to the capacitor, we are able to generate directional forces in either of two directions longitudinal to the electric field, the magnitude of which increases with the frequency of the applied pulses according to Equation (13). Note that the capacitor represented in FIGS. 1.A to 1.C is completely encapsulated by a dielectric 3, as expected for operation in the atmosphere in order to avoid uncontrolled discharges between the capacitor conductors. The theory developed here is valid for any type of capacitor, including symmetrical or asymmetrical capacitors (one of the electrodes having a different size or shape than the other).

When conductor 1 is used on the periphery or exterior or external surface of a vessel, Equation (13) also shows how capacitors formed by a single conductor 1, flat or curved, surrounded or not by a solid dielectric 3 (FIG. 1.D), can move by the emission of electric fields from its surface in a certain direction, due to the conservation of total momentum between fields and matter. Let us consider a metallic sphere of Cₛₚₕₑᵣₑ capacitance given by:

Cₛₚₕₑᵣₑ=4πε₀εᵣR (18)

Where εᵣ is the relative dielectric constant of the dielectric surrounding the exterior of the sphere and R is the radius of the sphere. The total energy of this sphere u_{E} will depend on the voltage V applied to its surface:

$${u}_{E} = \frac{1}{2} \frac{{Q}^{2}}{{C}_{sphere}} = \frac{1}{2} \frac{{( {C}_{sphere} V )}^{2}}{{C}_{sphere}} = \frac{1}{2} {C}_{sphere} {V}^{2} = - 2 π {ε}_{0} {ε}_{r} R {V}^{2} [ J ] \qquad ( 19 )$$

Where Q is the electric charge on the surface of the sphere and the negative sign at the end appears due to the negative potential interaction energy for dielectrics subjected to electric fields, Equation (1). The sphere energy provided by Equation (19) already includes the volume integration of the electric fields emitted by the sphere surface in space, and the energy distribution is symmetric and uniform around the sphere in all directions along the electric field lines, according to Equation (4). If we now electrically pulse the surface of this sphere uniformly, then no force would be developed due to the symmetry of the force vectors in all directions. If, however, we can electrically pulse only a single individual section of this sphere, then directional forces will be developed.

Since we have a spherical 3D symmetry, the perpendicular Cartesian components of the electric field flux and its energy will be equally distributed around an imaginary cube with 6 sides that surrounds the sphere, representing all six possible perpendicular directions for the propagation of the electric field flux and energy from the symmetric sphere. Thus, the energy emitted by only one of the perpendicular Cartesian components, for example in the direction of the positive x-axis, will be:

$${u}_{E x} = \frac{1}{6} {u}_{E} = - \frac{π}{3} {ε}_{0} {ε}_{r} R {V}^{2} [ J ] \qquad ( 20 )$$

We will consider that the metal sphere is decomposed into six different conductive or metallic 1 sections insulated from each other (FIG. 1.D), each corresponding to the six possible perpendicular directions around the sphere, each having one-sixth of the total capacitance of the sphere and emitting one-sixth of the total energy of the sphere in a given direction. If we now electrically excite only one of the six different possible sections, with a constant voltage, electric energy will be emitted only in one direction with electric field moment p_{Ex} given by:

$${p}_{Ex} = \frac{{u}_{Ex}}{c} = - \frac{π}{3 c} {ε}_{0} {ε}_{r} R {V}^{2} [ kg \cdot m \cdot {s}^{- 1} ] \qquad ( 21 )$$

The direction of the moment of the electric field will be opposite to the applied electric field vector (FIG. 1.E). We can develop directional forces in matter Fₘₐₜₜₑᵣ using electric displacement forces if we now apply a voltage V pulsed on a metal section:

$${F}_{m a t t e r} = \frac{{dp}_{matter}}{dt} = - \frac{{dp}_{Ex}}{dt} = - \frac{1}{c} \frac{\partial {u}_{Ex}}{\partial t} = \frac{2 π}{3 c} {ε}_{0} {ε}_{r} R V \frac{\partial V}{\partial t} = \frac{{C}_{sphere}}{6 c} V \frac{\partial V}{\partial t} [ N ] \qquad ( 22 )$$

When a positive voltage is applied, only to the metallic or conductive section 1 on the right side, with increasing magnitude, the electric field increases (∂E/∂t>) and the “space bending” force will be directed in the direction of the external electric field vector due to the increased electric field momentum opposite the electric field vector (FIG. 1.F). On the other hand, when the voltage and the applied electric fields fall in time (∂E/∂t<), then the developed mechanical force will be directed in the opposite direction of the external electric field vector due to the decrease of the electric field momentum in that direction (FIG. 1.G). The necessary balance between mechanical and electric field momentum, whose sum total and whose total time variation should be zero, Equations (7) and (9), provide the “space bending” forces generated by the conservation of total momentum.

If the derivative of the initial and final voltage or electric field are symmetrical, then no force will be generated. Equation (22) only develops directional forces when the derivative of the applied voltage or electric field is asymmetric. If in a given positive voltage pulse, the derivative of the first positive voltage increase (“rise time”) is faster than its subsequent decrease (“fall time”), then a force will be generated in the direction of the electric field vector (FIG. 1.F), and if the derivative of the voltage decrease (“fall time”) is faster than its initial increase (“rise time”) derivative, then a force will be generated in the direction opposite to the external electric field vector (FIG. 1.G). The force developed by each asymmetric pulse applied to the spherical mass considered, by applying voltage pulses to one of the six different sections considered, with capacitance C_{section}, will be given by:

$${F}_{Total} = \sqrt{{E}_{r} {μ}_{r}} \frac{{c}_{sphere}}{6 c} V \frac{\partial V}{\partial t} = \sqrt{{E}_{r} {μ}_{r}} \frac{{C}_{section}}{c} V \frac{\partial V}{\partial t} [ N ] \qquad ( 23 )$$

Where we add the term \sqrt{εᵣμᵣ} due to the change in the speed of light inside the dielectric, if one is used. As discussed with respect to Equation (13), Equation (23) also includes forces related to the variation in Polarization P of the dielectric material 3 used. In this case, using Equation (18) we can write that:

$${C}_{sphere} V \frac{\partial V}{\partial t} = 4 π {ε}_{0} {ε}_{r} R V \frac{\partial V}{\partial t} = 4 π {ε}_{0} R V \frac{\partial ( {ε}_{r} V )}{\partial t} .$$

That is, we again confirm the advantages of using dielectric materials 3, where the relative electrical permittivity varies in time in synchrony with the applied electric field (nonlinear dielectrics). As discussed in paragraph (19) in relation to Equation (13), the total force developed by Equation (23) will also increase in direct proportion to the number of pulses applied per second.

We have the option of using a pure sphere or metal section 1 without any coating, or the possibility of externally coating the surface of this sphere or section with a dielectric 3, which will allow the generated force to be increased substantially. For this reason, the conductor sections 1 depicted in FIGS. 1.D through 1.M, are also simultaneously designated by the number 3 due to the optional possibility of conductors 1 being covered by dielectric 3. On the other hand in these figures the dielectric 3 is also used to separate and laterally isolate each conductive section 1, so that each of the sections 1 can be individually used and electrically activated.

If we now reverse the polarity of the voltage applied to the metal section 1 to the right of the segmented conducting sphere to the negative, then if the voltage or electric field increases, the force generated will be directed to the left (FIG. 1.H), in the direction of the electric field vector. If the voltage or electric field decreases then the force will be generated to the right (FIG. 1.1), in the direction opposite to the electric field vector. As discussed earlier, when applying a voltage pulse, the total force will be generated in the direction of the major time derivative of the electric field.

There are several possible variations by which we might generate “space bending” forces using pulsed electric fields. Applications with positive or negative pulses on a single metal section 1 have been illustrated in FIGS. 1.F through 1.I. However, the force generated in a given direction can be increased in magnitude if opposite metal sections 1 are electrically excited with the appropriate pulses so as to generate forces in the same direction.

For example, there are four different ways to induce leftward “space bending” forces, which include a) when the electric field increases on the left and decreases on the right (FIG. 1.J), or b) when the electric field decreases on both the left and the right (FIG. 1.K), or c) when the electric field increases on the right and decreases on the left (FIG. 1.L), or d) when the electric field increases on both the left and the right (FIG. 1.M).

As we can see (FIGS. 1.A to 1.M) the capacitor, composed of one, two or more conductors 1 and/or 2, will move in the necessary direction to satisfy the conservation of total momentum of the space-time around it. Let us now explain in more detail the use of the terms “inertia attenuation”, “space warp” and “direct action on space-time”. The theory of the present patent application was developed for the explicit purpose of seeking to explain experimental observations of forces in capacitors that occurred without the emission or expulsion of physical matter as occurs in the conventional rocket concept. We note that the force developed in capacitors is due to the asymmetric rate of change of the electric linear momentum, that is, when the variation of the electric linear momentum is greater in a given direction, directional mechanical forces will be generated in the capacitor. This observation is also a theoretical necessity, a consequence of the total conservation of momentum when we account for the variation of the mechanical momentum with the electric field momentum. In reality the operation of this system is very similar to that of a conventional rocket, but in this case instead of matter being expelled in a given direction, only energy is expelled. The energy (and its equivalent “mass”) expelled is very small, but this is offset by the speed of propagation of the electrical distortions being the speed of light, and also due to the use of extremely fast rates of temporal variation of the momentum associated with this energy, which for this reason is able to generate relevant observable forces.

In relativity theory, the energy-momentum tensor of space-time from which “space warp” distortions are achieved considers space-time to be a kind of perfect fluid, the source of gravitational interactions (Gron, O., and Hervik, S., “Einstein's General Theory of Relativity,” Springer Science, 2007; Osvaldo, L. S.-P., et al., “Fluid dynamics in the warp drive spacetime geometry,” Eur. Phys. J. C81, 133, 2021). The theory presented in this patent expands on the previous concepts by considering that the velocity of space-time or this perfect fluid is proportional to the electric linear momentum, and that the acceleration of this space-time is proportional to the time variation of the electric linear momentum. In this way, directional forces will be developed only if the temporal variation of the electric linear momentum is asymmetric.

As confirmation of this theoretical proposal we have experimental results that only make sense if the linear momentum of space-time, i.e. the velocity state associated with space-time is directly related to the electric linear momentum and if the acceleration of space-time is associated with the asymmetric variation of the electric linear momentum. We mention a specific case of application of our experimental observations. In this case, we observed that a capacitor with 5.3 pF of capacitance where −40 kV was applied generates a force of approximately 2 mN when the voltage drops abruptly to zero in about 20 ns, and the linear increase of this force up to 10 mN was observed in direct proportion with the increase in frequency of the asymmetric pulses. This case is merely illustrative to demonstrate that the concept works as described.

It is known from the literature that “space drive”, “warp drive” or “space warp” type thrusters use the matter or energy of spacetime itself as the means of locomotion (Osvaldo, L. S.-P., et al., “Fluid dynamics in the warp drive spacetime geometry,” Eur. Phys. J. C81, 133, 2021). As stated by Campbel (Campbell, J. W., “The space drive problem”, Astounding/Analog (US), pp. 83-106, June 1960) e Clarke (Clarke, A. C., Profiles of the future: An inquiry into the limits of the possible, Harper & Row, New York, 1962): “A space drive is a propulsion mechanism that acts directly upon the fabric of free-space”, that is, the propulsion mechanism associated with the “space drive” acts directly on the free space or space-time fabric through a “space warp” or “direct action on space-time”.

It is well known that Einstein showed that an object accelerated by a force originating in space-time such as the gravitational force does not undergo inertial forces (Nobili, A. M., et al., “On the universality of free fall, the equivalence principle, and the gravitational redshift,” Am. J. Phys. 81, 527, 2013). Any object that is accelerated by a gravitational force continues to maintain its inertial mass (inertial mass is not cancelled) but when falling freely into a gravitational field the object will not feel its own weight and will not feel inertial forces. It was this concept that according to Einstein gave rise to his theory of General Relativity as mentioned in the reference above.

Although the “space drive” and “warp drive” type force have a different origin than the gravitational force generated by physical masses, because they are generated by the energy (and equivalent mass) of electromagnetic fields, they both act on other masses and generate forces on those masses by direct manipulation of space-time. Einstein's General Theory of Relativity (Gron, O., and Hervik, S., “Einstein's General Theory of Relativity,” Springer Science, 2007) uses Riemann's approach, in purely geometric terms, to explain the origin of gravitational and electromagnetic forces as originating in the deformation of space-time, considering that space-time is curved, manipulated, or distorted by the presence of matter or energy. However, the problem with this approach is that it is purely mathematical without proposing a physical mechanism for how the deformation of space-time takes place. Einstein helped in understanding the problem by suggesting that the warping, bending or curvature of space-time is directly correlated to the presence of energy-matter in that space, E=m·c², however Einstein could not explain exactly how mass or electromagnetic interactions are able to warp space-time generating the gravitational and electromagnetic forces (Kaku, M., “Hyperspace,” Oxford University Press, 1994).

Inertia exists in all objects that are accelerated by mechanical forces (transmitted between masses by local electromagnetic repulsion forces between the electron clouds of neighboring atoms) and that in their entire volume move “against” space-time and not “by” the deformation of space-time. The theory shown so far shows how it is possible to manipulate the state of velocity and acceleration of space-time by the electric linear momentum and its time variation, being able to generate forces by the asymmetric flow of the variation of the electric linear momentum in a given direction. In simple terms, this means that a directional flow of energy (or equivalent “matter”, E=m·c²) is generated by the asymmetric variation of the electric linear momentum, that is, a local deformation of space-time will be caused where forces will be generated without inertia only in the volume where the asymmetric flow of energy takes place. In contrast, the ordinary gravitational force is generated by the constant energy gradient (curvature) induced in space-time by the presence of a mass.

This dynamical approach expands Einstein's initial concepts of static energy and mass to manipulate space-time, which were later expanded by him to include gravitational waves generated by the oscillation of matter and which have recently been observed experimentally (Abbott, B. P., et al., “Observation of gravitational waves from a binary black hole merger,” Physical Review Letters 116, 061102, 2016).

Instead of oscillating physical matter, as proposed by Einstein, to generate gravitational waves, the system proposed in this patent asymmetrically oscillates the energy (and therefore its equivalent mass, m=E/c²) accumulated in the capacitor thus generating asymmetric gravitational waves of small amplitude per asymmetric pulse, but with sufficient intensity to, in conjunction with the increase in the repetition rate of the pulses, generate asymmetric forces of great relevance, with varying magnitude, in the structure of the same.

For this reason, to attenuate or reduce the inertial force on the occupants of a ship or vehicle the deformation of space-time will have to be accomplished using thrusters the size of the ship itself (or using several smaller thrusters with an equal resultant) in order to manipulate the asymmetric flow of energy throughout its volume. If “space drive” or “warp drive” type thrusters are used with a size that is not capable of deforming space-time in the complete volume where inertia needs to be removed, then it will not be affected. In this way, we try to clearly show the physical mechanism and the conditions under which “inertia attenuation” may occur.

As we mentioned at the beginning of this patent, the state of the art in terms of propulsion with “inertia reduction” is given by the patent: U.S. Pat. No. 10,144,532 B2: Craft using an inertial mass reduction device, 2018. The author of this patent has two published papers (Pais, S., “A hybrid craft using an inertial mass modification device,” AIAA 2017-5343, AIAA Space and Astronautics Forum and Exposition, Orlando FL, Sep. 12-14, 2017; Pais, S., “High Frequency Gravitational Waves—Induced Propulsion,” SAE Technical Paper 2017-01-2040, 2017) where it is illustrated how the term “inertial attenuation” is used within the context of space-time manipulation by electromagnetic systems.

Note that by using conductors 1 on the exterior or surface of the ship FIGS. 1.D through 1.M driven by asymmetric voltage pulses or electric field, repulsion forces will be generated on any external mass that is in the line of motion of the ship as given by Equation (13). This implies that the atmosphere will automatically be repelled, or if the ship is surrounded by water, then the water itself will also be repelled in the direction of the ship's motion, just as any object in the ship's line of motion will be repelled as it moves through space.

In this propulsion system, teleportation will be generated when V ∂V/∂t, or E·∂E/∂t, exceed a certain threshold value. The phenomenon happens because the electric field E is proportional to the space-time velocity through the relationship for the electric field linear momentum, which is equivalent to the space-time linear momentum, as given by Equation (10). Regardless of the direction of the space-time velocity with respect to the electric field vector E, we can observe that ∂E/∂t represents an acceleration of space-time, which behaves like a superfluid as explained in Einstein's theory of Relativity (Gron, O., and Hervik, S., “Einstein's General Theory of Relativity,” Springer Science, 2007). As is known in fluid dynamics, under the name supercavitation, when a fluid is accelerated, above a certain limit velocity, then a phase change will occur in the fluid from liquid to gas phase, for example, dramatically decreasing its density and consequently dramatically increasing the velocity of propagation allowed through it.

Thus, by applying a single asymmetric pulse of extremely high magnitude, V·∂V/∂t or E·∂E/∂t, above a given transition value, teleportation will be generated in the same direction as the “space warp” force, Equations (11) and/or (13) and/or (23), where the distance traveled in a single teleportation “jump” will depend on the total magnitude of the pulse used. For the generation of teleportation and the displacement of masses without inertia, the generation of asymmetrically pulsed electric fields, distributed completely or partially within or around the mass to be transported, is required.

Using Equation (2), Equation (14) can also be written as:

f_{KE}=P·∇E=E·∇P=ε₀E·∇[(εᵣ−1)E] (24)

Therefore, when we pulse electric fields, the force generated will be proportional to the spatial (or temporal) gradient of the electric fields, but also proportional to the gradient of the relative electric permittivity εᵣ of the dielectric material 3 used in the capacitor. Equation (24) also gives the force generated when the applied voltage and electric field are constant, oscillating, rectified oscillating or pulsed, with symmetrical or asymmetrical capacitors. If the capacitor is symmetric and the electric field constant, then the force generated will be given by:

f_{KE}=ε₀E·E(∇εᵣ−1) (25)

That is, the force will be proportional to the spatial gradient of the relative electrical permittivity εᵣ of the dielectric material 3 used in the capacitor. This is another way to use capacitors for propulsion using the application of constant, oscillating, rectified oscillating or pulsed electric voltages and fields. Dielectric 3 may be of one or more materials, uniform or non-uniform individually, placed or used in such a way that they generate a gradient of the relative electrical permittivity εᵣ along dielectric 3 in a given direction.

Although our preferred application uses asymmetrically pulsed electric voltages and fields with uniform dielectrics 3, the application of non-uniform dielectrics 3 may increase the force generated if the gradient of the relative electric permittivity Er of the dielectric material 3 used generates a force in the same direction as the applied asymmetric pulses. Our specific configurations for constant or oscillating voltage application use only capacitors fully encapsulated by dielectric 3, since the use of constant or oscillating voltages for propulsion in asymmetric capacitors with a gradient of the relative electrical permittivity εᵣ of the dielectric was used in U.S. Pat. No. 3,187,206 (1965) cited above, where all the conductors of the capacitors used were exposed to the atmosphere and not fully encapsulated as here.

### BRIEF DESCRIPTION OF THE FIGURES

The present invention will now be described in detail, without limitation and by way of example, by means of preferred embodiments, represented in the attached drawings, in which:

FIGS. 1.A to 1.M describes the theory of the “space warp” or displacement/polarization force that acts on capacitors, due to the total conservation of linear momentum.

FIG. 2.A to 2.G represents various forms of electrical excitation to generate propulsion in capacitors.

FIGS. 3.A to 3.Y represents various forms of application of propulsion systems using capacitors.

FIGS. 4.A to 4.P represents various forms of application of propulsion systems, attenuation of inertia and generation of force fields, using capacitors where the same conductor 1 is shared by several conductors 2.

FIG. 5.A to 5.O represents various forms of application of propulsion systems, attenuation of inertia and generation of force fields, using capacitors with a single conductor 1 that can be segmented.

FIG. 6.A to 6.F represents various ways of applying the propulsion units to structures with different geometries.

### DESCRIPTION OF THE PREFERRED EMBODIMENT

With reference to the figures, the preferred embodiment of the invention will now be described. In the attached figures, equal numbers correspond to equivalent components in the different configurations.

Each of the configurations we will describe results from a natural development of the previous one, using the same physical principles to generate the propulsion forces described above, being natural and different variations that complete and complement each other.

Consider a capacitor formed by a conductor 1 and another conductor 2, both disc-shaped, connected to a power supply 5, which generates a static, oscillating, rectified or pulsed voltage, and separated by the dielectric 3. For this and all other configurations we consider conductor 1 to be positive and conductor 2 to be the opposite polarity, with either of these conductors having the possibility of reversing their original electrical polarity or also being the ground or zero reference.

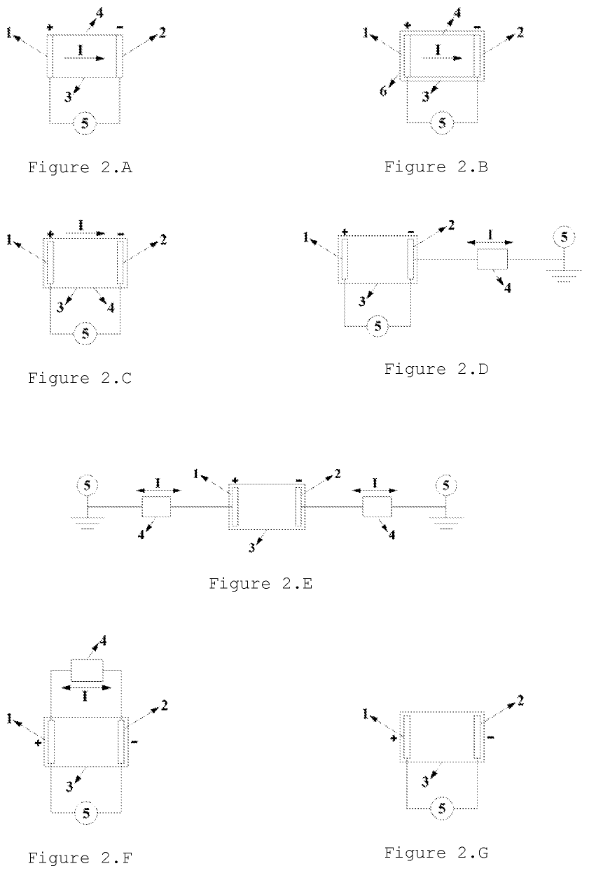

Under these conditions (FIG. 2.A), and the assembly being in a vacuum or in the atmosphere, when a threshold voltage is exceeded between conductors 1 and 2, a discharge will be generated through dielectric 3, by volume if it is a gas or through its surface if it is a solid. In the first case we have “spark gap” discharges in vacuum or with gas at low or high pressure and in the second case we have a “surface discharge” along the surface of the used solid or liquid dielectric. This discharge will cause a conduction current I to run through the dielectric 3 which behaves under these conditions as a switch with resistive load 4 which dissipates the energy of the capacitor causing the voltage in conductors 1 and 2 to drop sharply. This sudden voltage variation will generate a force on the capacitor according to Equation (13). This assembly may also be inserted inside a dielectric or conductive or magnetic shielding or enclosure 6, for the purpose of protection or to maintain inside a vacuum or gases suitable for its operation (FIG. 2.B).

In our preferred case with the capacitor formed by conductors 1 and 2 completely wrapped inside a dielectric 3, there is also the possibility of the occurrence of a surface discharge along dielectric 3, thus generating propulsion forces as well (FIG. 2.C), although this condition is not encouraged due to the erosion of dielectric 3 with time. By using a greater thickness of the dielectric 3, we can avoid this type of discharges.

Propulsion forces may also be generated if an electrically charged capacitor, has one of its conductors abruptly charged or discharged via a power supply 5 or by a resistive (or inductive) switch 4 (FIG. 2.D). To generate propulsion forces, both conductors 1 and 2 may be abruptly charged or discharged by power supplies 5 through the optional use of appropriate resistive switches 4 (FIG. 2.E). The resistive switch 4 may be made up of normal resistors with or without a switch, or preferably by “spark gap” type switches including “surface discharge” switches in dielectrics. The resistive switches 4 used should preferably have the fastest discharge time, in order to generate greater forces, or they could be designed in order to obtain the discharge times and with a pulse repetition suitable for each application.

Another option will be to charge said capacitor through a power supply 5, which delivers static voltage, and use a resistive switch 4 to abruptly charge or discharge the capacitor, generating propulsive forces (FIG. 2.F). Our preferred configuration, however, will be to use a capacitor completely encapsulated in a dielectric 3, using only a power supply 5 that directly debits appropriate voltage pulses with asymmetrical E·∂E/∂t derivative inside the capacitor, directly generating propulsion forces (FIG. 2.G).

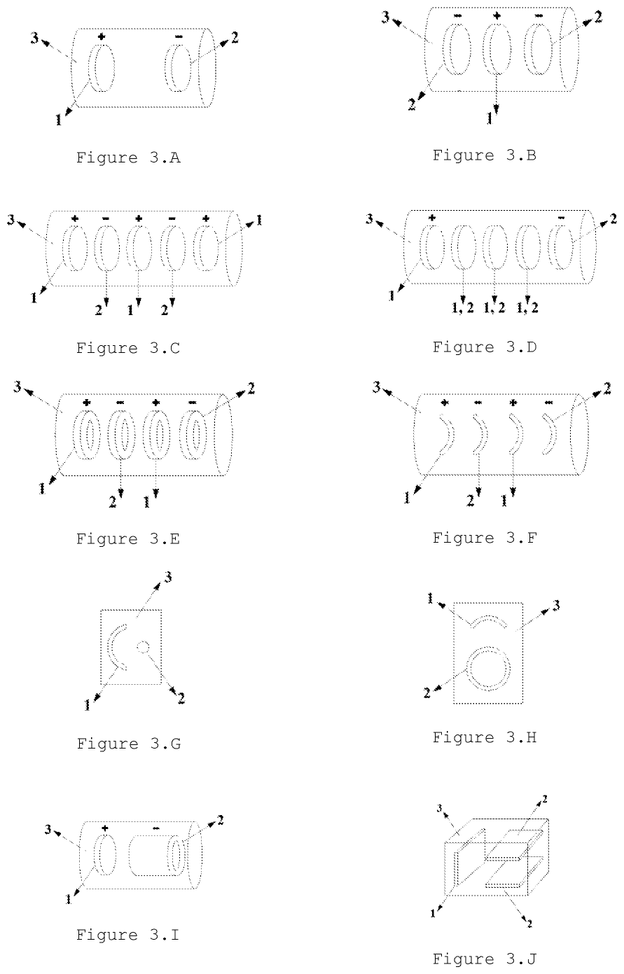

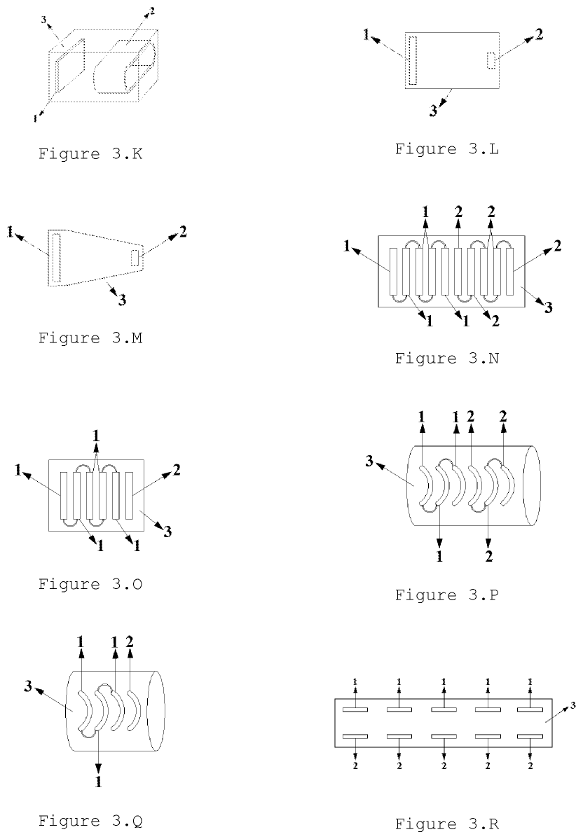

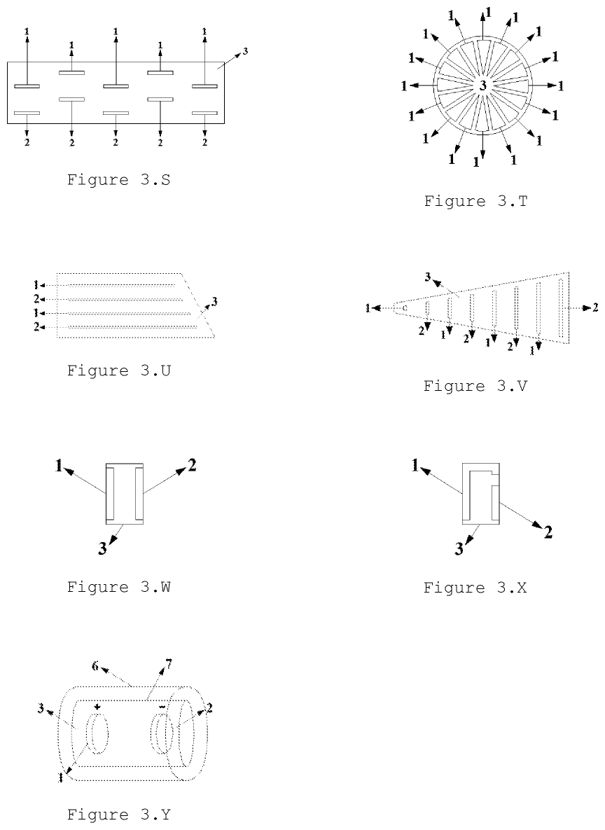

Our preferred configuration using a capacitor completely encapsulated in a dielectric 3 will be able to use disk-shaped conductors 1 and 2 and generate propulsion forces in both directions perpendicular to the face of the conductors depending on the shape of the applied pulse (FIG. 3.A). If the power supply 5 debits a pulse shape that generates forces only in one direction, then we can use a third conductor 2 in order to control the direction of the force produced by electrically feeding conductor 2 used to the right or left of conductor 1, to generate forces in opposite directions (FIG. 3.B). We can use any number of conductors 1 and 2 in succession in the same capacitor, where all can be connected to power supplies 5 or only the external conductors (FIGS. 3.C and 3.D), and where conductors 1 and 2 can assume any electrical polarity (FIG. 3.D).

The force of Equation (13) works for any type of capacitor that has electric field vectors that do not cancel each other, and has asymmetric E·∂E/∂t derivatives when varying them. In this way, the possible variations of geometry used for conductors 1 and 2 are unlimited and may include any geometry or cross-section other than those specifically mentioned. As a non-limiting example, conductors 1 and 2 may include circular, cylindrical, oval, ellipsoidal, convex, concave, square, rectangular, triangular, hexagonal and so on, solid or hollow geometries with a hole in the middle, and any mixture thereof. The geometries used in conductors 1 and 2 may be equal to each other and with equal or different relative size, and these may also not be equal to each other in their geometry or size.

Some non-limiting examples of these variations are given in FIGS. 3.E through 3.X, where conductors 1 and 2 in ring or toroid form may be used (FIG. 3.E), with the surrounding dielectric 3 accompanying the central opening or not. Another variation is the use of several curved conductors 1 and 2 in succession (FIG. 3.F) or a curved conductor 1 with a flat conductor 2, or a curved conductor 1 and a spherical or discoid conductor 2 (FIG. 3.G). Or a ring-shaped conductor 2 facing a curved conductor 1, which could be a curved surface or a wire (FIG. 3.H). Other variations include using cylindrical conductors (FIG. 3.I), or horizontal planes (FIG. 3.J) that are linear or close in on themselves (FIG. 3.K), where conductors 1 and 2 do not need to be equal to each other. We can also use asymmetrical flat or curved conductors 1 and 2, that is, with a relative size different from each other, where dielectric 3 does not follow (FIG. 3.L) or follows the asymmetry of conductors 1 and 2 (FIG. 3.M).

Another variation that allows the capacitance of a capacitor completely surrounded by element 3 to be increased will be by connecting several elements 1 parallel and independent of each other in series, increasing the total capacitance of the several elements 1, using any number of elements 1 in series. By making the same type of series connection for several elements 2 parallel and in series, in equal number used for elements 1 we will have a symmetrical capacitor of multiplied total capacitance (FIG. 3.N) that will generate a greater force for the same applied pulse. If the number of series elements used for the total of elements 1 and 2 is different for elements 1 or 2 (FIG. 3.O) we will have an asymmetric capacitance capacitor that will generate a larger force depending on the direction of the capacitance gradient. In this case we can apply direct or oscillating voltages, and if we apply asymmetric electrical pulses, these should be chosen so that they generate a force in the same direction caused by the capacitance gradient. In addition to flat shapes (FIGS. 3.N and 3.O) we can use elements 1 and 2 with a convex shape (FIGS. 3.P and 3.Q) or any other shape.

Despite all these possible variations, our preferred configuration uses only disk-shaped conductors 1 and 2, as in FIGS. 3.A through 3.D, or rectangular and long, with possible horizontally aligned cross-section (FIG. 3.R) or with variations on that horizontal alignment (FIG. 3.S).

Another geometry preferred by us includes conductors 1 and 2 with a triangular shape, simple or similar to that of pizza slices, distributed horizontally in a lateral circular fashion along 360° (FIG. 3.T), where the lateral conductors 1 and 2 may be driven in an isolated and independent manner or all may be driven simultaneously and interconnected, and these may be subjected to opposite or equal polarities in the same horizontal plane, the application of equal polarities being preferable (FIG. 3.T). In this case, the pizza configuration of conductors (FIG. 3.T) could be a top view of an assembly with cross section aligned or not horizontally (FIGS. 3.R and 3.S), and where conductors 1 and 2 can maintain or change their size and dimensions along their cross section, and the assembly can have a 3D cylindrical (FIGS. 3.R and 3.S), or angular or conical (FIGS. 3.U and 3.V) shape. The configuration in FIG. 3.T has the advantage of controlling the direction of the force generated by the choice of conductors 1 and 2 excited by power supply 5, allowing you to easily change the direction of the resulting force vector.

Preferably when the voltage used on conductors 1 and 2 is lower than the ionization voltage of the surrounding gas we can partially expose conductors 1 and 2 to that gas (or atmosphere or environment) (FIGS. 3.W and 3.X). In addition to symmetrical capacitors exposed to the atmosphere (FIG. 3.W) we may also use asymmetrical capacitors, where an additional possible variation includes part of conductor 1 being extended or partially extended in a small tab or extension (or more than one extension) to the opposite surface where conductor 2 is FIG. 3.X, and/or reciprocally conductor 2 optionally having one or more tabs or extensions to the surface where conductor (1) is located. This is a widely used conductor configuration in piezoelectric capacitors that allows connecting wires to be used with conductors 1 and 2 on the same surface, and can be used in our case, with conductors 1 and 2 partially or completely surrounded by dielectric 3.

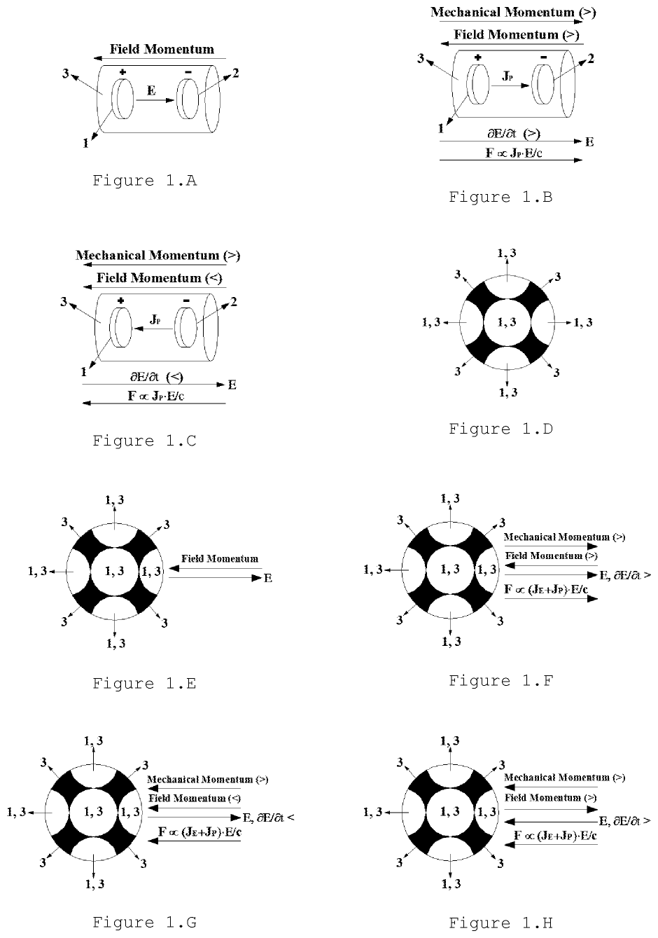

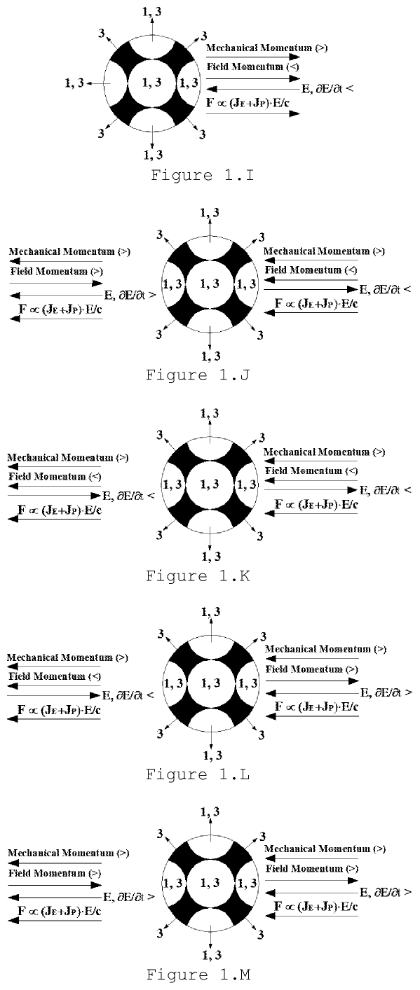

All the configurations shown in FIGS. 1.A to 1.M, 2.A to 2.G and 3.A to 3.Y represent propulsion units 7, which can be optionally wrapped and shielded by dielectric or conductive or magnetic materials 6 for the purpose of containing in space the electromagnetic fields generated by propulsion units 7 in such a way as to prevent electromagnetic emission that could impair the operation of nearby electrical equipment (FIG. 3.Y), as well as to prevent exposure to these fields of people or biological material or equipment (or any other material) near the propulsion units 7. Another possible function of using an envelope 6 will also be in increasing the capacitance of the propulsion unit 7 used. Note that conductors 1 and 2 can be thin as paint or thin film, and made of any conductive, superconducting or semiconducting material, with the possibility or option of painting their surface with paint of small conductive, semiconducting or magnetic particles, or nano particles of carbon, graphene or any other material, with positive or negative permittivity or permeability, in order to increase their total capacitance or improve their properties.

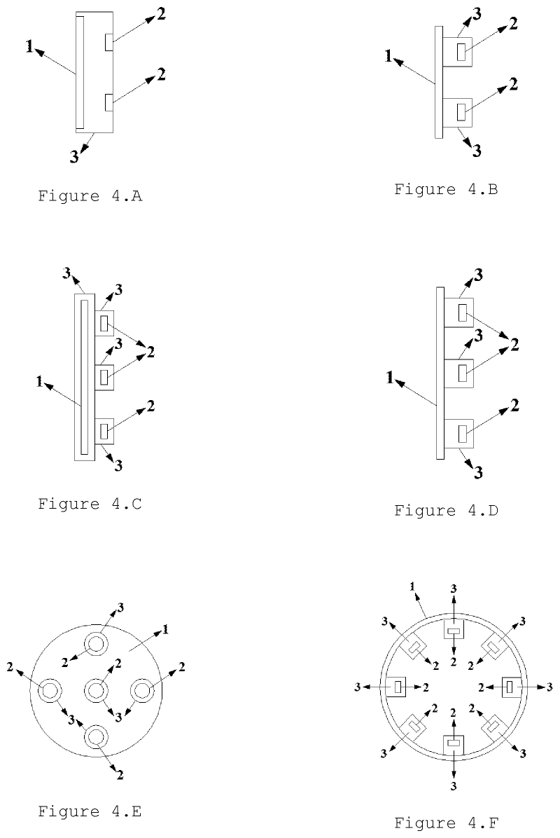

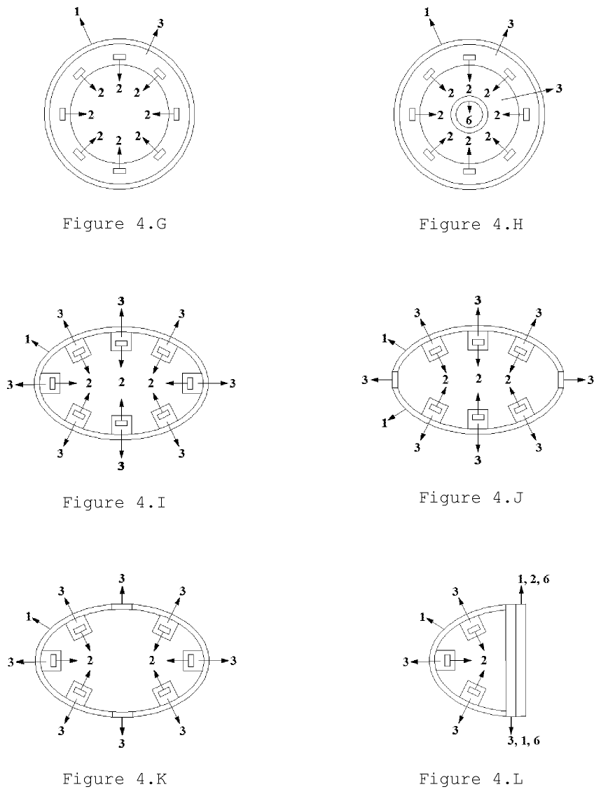

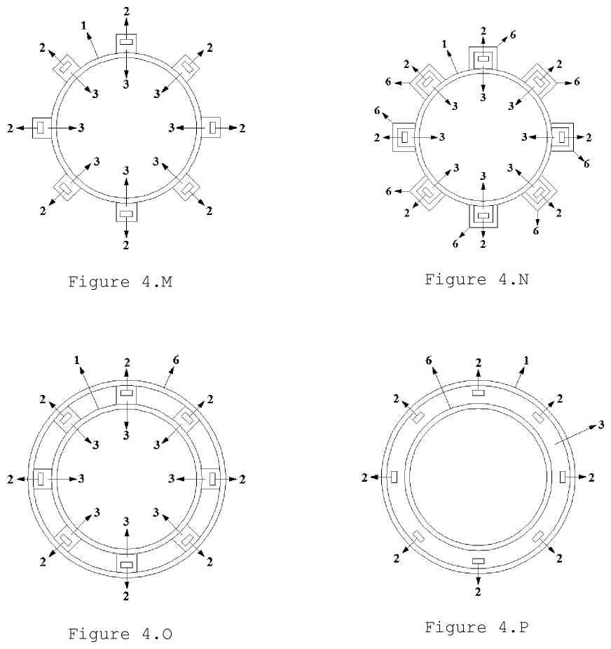

So far we have used common capacitors with one conductor 1 to another conductor 2, where several conductors were used aligned in parallel in order to increase the capacitance and flexibility of the propulsion system. Let us now consider another variation of simpler and more efficient application. In this case we will use capacitors with a single conductor 1 to two or more conductors 2, separated by dielectric 3 (FIG. 4). In this case, both conductors 1 and 2 may be exposed to the outside environment without dielectric protection (FIG. 4.A), or only conductor 2 may be completely enveloped by dielectric 3 (FIG. 4.B), or both conductors 1 and 2 may be partially or completely enveloped by dielectric(s) 3 (FIG. 4.C).

We may use any number of conductors 2 in conjunction with a conductor 1, distributed randomly or in any pattern and geometry, such as by non-limiting example using distribution patterns of conductors 2 triangular, quadrangular, pentagonal, hexagonal, circular, rectangular, ellipsoidal, and others, with or without one or more conductors 2 placed at the center of that distribution. For example, we might use three conductors 2 together with a conductor 1, separated by dielectric 3, where conductors 1 and 2 might be completely enveloped by dielectric 3 (FIG. 4.C) or where only conductor 2 or 1 might be exposed to the environment (FIG. 4.D). A front view of the cross section of FIG. 4.D might use conductors 2 in a triangular distribution pattern with another conductor 2 in the center, or where conductors 2 might be in a quadrangular pattern with another conductor 2 in the center (FIG. 4.E).

Both conductors 1 and 2 may have any geometric shape, two-dimensional or three-dimensional. So far we have considered flat conductors 1 (FIGS. 4.A through 4.E), but these may also have two-dimensional flat ring round shapes or three-dimensional hollow spherical shapes (FIG. 4.F). In this case we can have any number of conductors 2 distributed in any arrangement inside conductor 1 and separated from it by dielectric 3. For example, by using eight conductors 2 inside conductor 1 (FIG. 4.F), we can generate propulsion forces in any of the eight available directions in a controlled manner. The dielectric 3 may wrap only a limited area around conductor 2 (FIG. 4.F) and/or the dielectric 3 may be distributed in a uniform (or non-uniform) layer completely inside conductor 1 (FIG. 4.G). In order to protect people, equipment or any other material, we can use a material 6 inside conductor 1 (FIG. 4.H), accompanying or not or dielectric 3 that surrounds each conductor 2. This material 6 may also cover externally, in isolation or individually, each conductor 2 and respective dielectric 3.

As we mentioned, several other shapes for conductor 1 could be used, such as circular, round, spherical, tubular, square, triangular, pentagonal, hexagonal, or oval shapes made from a single conductor 1 (FIG. 4.1). This shape may be made of a single conductor 1 (FIG. 4.1), or the same shape may be made with several independent sections of several conductors 1, in electrical contact with each other or separated by dielectric 3, or separated by any other material. For example, we could segment the same oval shape into two independent sections, an upper and a lower one, separated by dielectric 3 (FIG. 4.J). Or we can segment the same conductor 1 into two independent sections, one on the right and one on the left (FIG. 4.K), separated by the dielectric 3. Or we can segment conductor 1 into four different sections, above, below, right and left in a mixture of the two previous cases; where conductor 1 could be segmented into any number of independent sections.

Another alternative shape for conductor 1 could be a curved section corresponding to half a sphere or oval (FIG. 4.L). In this case the flat part on the right may consist of conductor 1, or material 6, or dielectric 3, independently or simultaneously; where dielectric 3 may optionally separate curved conductor 1 from another flat conductor 1, or flat conductor 2, or flat material 6. We have mentioned only a few forms of all the variety that will be possible.

So far we have used conductors 2 on the inside of curved conductors 1 (FIGS. 4.F through 4.L) but conductors 2 may also be used similarly on the outside of curved conductor 1, separated from each other as before by dielectric 3 individually (FIG. 4.M). Each of the conductors 2 and external dielectrics 3 can be optionally protected by the material 6 individually (FIG. 4.N) or globally (FIG. 4.O), where we can use the dielectric 3 individually on conductors 2 (FIG. 4.O), or dielectric 3 (or several dielectrics 3), may be used globally involving all conductors 2 between conductor 1 and material 6 (FIG. 4.P), and where conductor 1 and material 6 may be used reciprocally within or outside of each other (FIGS. 4.O and 4.P). The relative position of conductor 2 between conductor 1 and material 6 (which could also be another conductor) can be calibrated for the purpose of more efficient propulsion generation. The external and/or internal side of conductor 1 (or material 6 if it is a conductor) may optionally be covered by any type of dielectric 3 in order to increase its capacitance.

If we excite the external conductor 1 of the propulsion configurations shown in FIG. 4 with voltage pulses or asymmetric electric fields, we will generate additional propulsion forces in addition to the forces generated by interaction with conductor 2. These additional propulsion forces are given in general form by Equation (23) and have been discussed in the configurations shown in FIGS. 1.D through 1.M, by applying asymmetric voltage or electric field pulses to whole or segmented curved conductors 1 or any shape or geometry. In this case, the forces generated are independent of the use of conductor 1 in conjunction with conductor 2, due to the interaction that the external conductor 1 has with its external environment which in this case behaves like a “virtual” conductor 2. In this way we can also generate propulsion forces if we electrically excite or use only the outer conductor 1 and subject it to asymmetric voltage pulses or electric field.

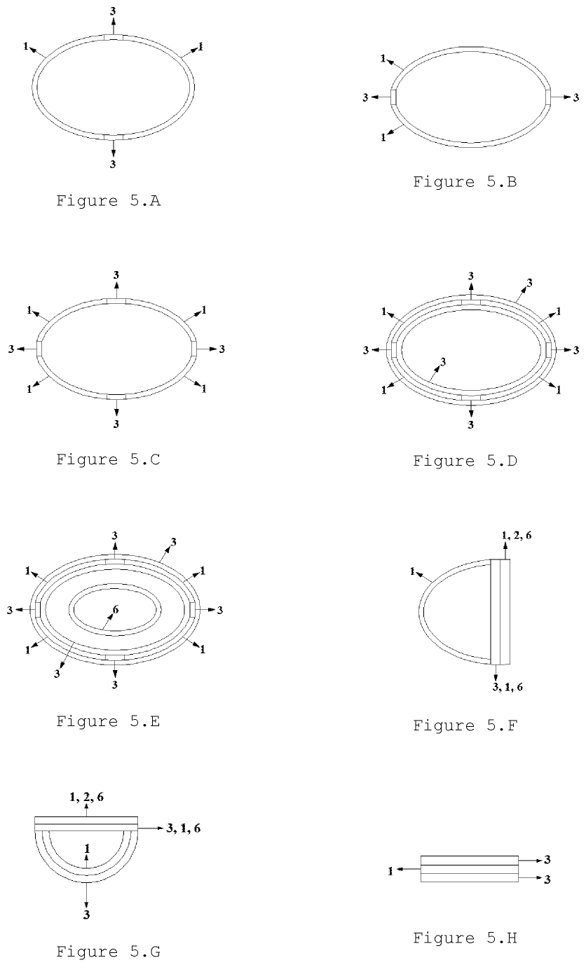

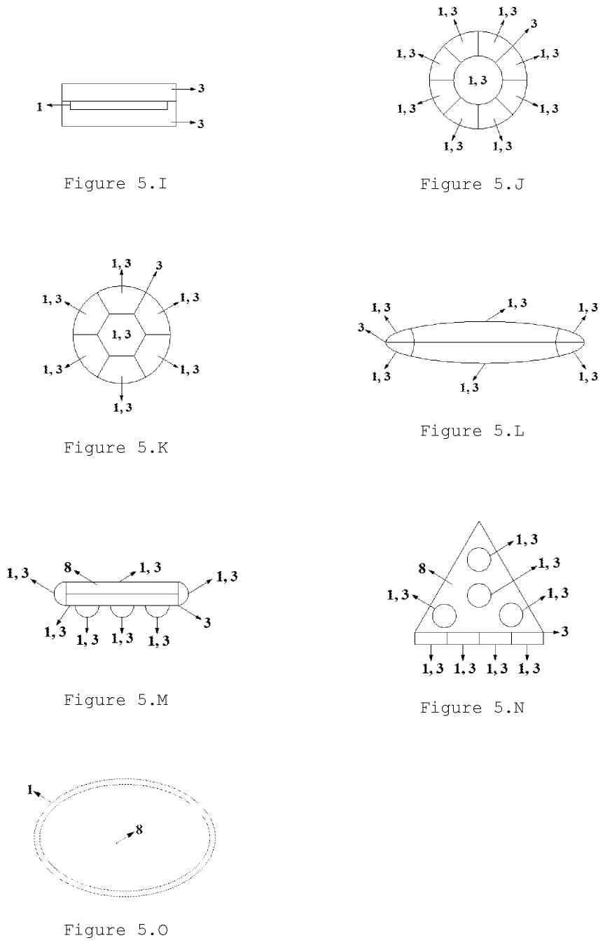

In this way we can use two or more external conductors 1 in any number of independent conductive sections 1, separated by dielectric 3, or separated by any other material. For example, we might segment the same oval shape into two independent sections, one on the right and one on the left, separated by dielectric 3 (FIG. 5.A). Or we can segment the same conductor 1 into two independent sections, one upper and one lower (FIG. 5.B), separated by dielectric 3. Or we can segment conductor 1 into four different sections, above, below, right and left in a mixture of the two previous cases (FIG. 5.C). In order to increase the capacitance of the outer conductors 1 these can be optionally externally coated by dielectric 3 (FIG. 5.D). The same external conductors 1 may also optionally be internally lined by dielectric 3 (FIG. 5.D). The various segmented conductors 1 used to generate an overall spherical, oval or any other shape already naturally negate the presence of any electric field inside, however, an optional material 6 internal to the segmented conductors 1, and internal dielectric 3, may be used to additionally shield any material from any electric field or electromagnetic radiation that may exist (FIG. 5.E).

Another alternative shape for conductor 1 could be a curved section corresponding to half a sphere or oval (FIG. 5.F). In this case the flat part on the right may consist of conductor 1, or material 6, or dielectric 3, independently or simultaneously; where dielectric 3 may optionally separate curved conductor 1 from flat conductor 1, or flat conductor 2, or flat material 6. We mention only a few forms of the whole variety that will be possible, where the curved conductor 1 (or the flat conductor 1 or 2) may be coated internally and/or externally by dielectric 3 as described earlier (FIG. 5.G).

Flat conductors 1 can generate propulsion forces if they have dielectrics 3 on opposite faces with different values of relative electrical permittivity, where the different dielectrics 3 can partially (FIG. 5.H) or completely (FIG. 5.I) surround conductor 1.

Several non-limiting examples of how several conductors 1 separated by the dielectric 3, may be arranged into several different geometries will be given below. Since conductors 1 are preferably and optionally externally wrapped by dielectric 3, we use the designation of both simultaneously. Simple lines separating these elements represent dielectric 3. The simplest shape will be the spherical shape segmented into any number of sections (FIG. 5.J). This spherical shape may use curved, round or spherical conductors 1 (FIG. 5.J) or the same spherical shape may consist of conductors 1 with hexagonal sections that fit perfectly together (FIG. 5.K). Alternatively, oval (FIG. 5.L) or cigar (FIG. 5.M) shapes could be used to move a mass 8, where several smaller conductors 1 could be used additionally creating macroscopic and microscopic composite shapes (FIG. 5.M). Another option could be the use of global triangular shapes with several additional smaller conductors 1 used to vectorially control the generated force (FIG. 5.N). We have mentioned only a few of the many possible options.

Dielectric 3 can consist of any solid, liquid or gaseous material, and can have a positive or negative, linear or non-linear relative permittivity, which will influence the direction and magnitude of the force generated, or even be vacuum itself or a gas at low or high pressure. This dielectric 3 may be pure or be a symmetric or asymmetric mixture of several different dielectrics, and may contain optionally embedded within it, symmetrically or asymmetrically, any number of small conductive, or semiconducting, or non-conductive, or magnetic, or nano particles of positive or negative, linear or non-linear permittivity or permeability, such as metallic, or magnetic, or semiconducting, or other powder or paint. Dielectric 3 may include the use of piezoelectric, or pyroelectric, or ferroelectric, or metamaterials, or glass, or quartz, or ceramics, or plastics, or any other type of dielectric. Where dielectric 3, and/or material 6, and/or conductors 1 or 2 may be metal matrix composite materials, and/or ceramic matrix composite materials, and/or carbon matrix composite materials, and/or polymer matrix composite materials, among many other possibilities.

The propulsion units 7 can be independent or on the contrary be connected together in any distribution or grid. In all propulsion units 7 we can use ultra-capacitor properties and specifications or use materials that generate superconductivity or cooling systems for superconducting operation. We can also use in all propulsion units 7 any power supply 5 of high or low voltage or current, constant, oscillating, rectified oscillating, pulsed or any other, including asymmetrical pulses (E·∂E/∂t asymmetrical) or pulses with asymmetrical voltage derivative, in conjunction or not with resistive switches 4. Examples of non-limiting power supplies 5 include Marx generators, inductive voltage pulse generators, microwave generators with asymmetrical voltage pulses, among many other options.

A protective force field may be generated by the propulsion units 7 or by a single whole conductor 1 (FIG. 5.O) or segmented, with arbitrary shape (FIGS. 4.A to 4.P and 5.A to 5.O) placed around an arbitrary mass 8, moving or stationary, where in the latter case the total resulting force on the mass 8 will be symmetric and zero, due to the symmetric application of the force fields, but any object approaching the mass 8 will be strongly repelled, with total force given by Equation (13) where Vₒₗ will be in this case the volume of the external object being repelled. Any small asymmetry in the force fields will allow the movement of mass 8 in a given direction with full protection by the generated force fields. Possible applications of these force fields are numerous and include the reduction of atmospheric or water friction for cars, airplanes, boats, or submarines, allowing water vehicles to move to any depth, as well as moving spacecraft in space, in the atmosphere, or on water, completely protected and free from collisions with masses. As an example of application of the generated force fields, we have the repulsion, attraction or deflection of space debris or hazardous asteroids to planet Earth, or direct transport of asteroids using the repulsion or attraction forces generated by the force fields. Another application will be to extinguish forest fires or any kind of fires simply by using the repulsion forces generated by force fields by the approach of an airship or object using a propulsion system like the one reported in this patent, which generates force fields at a distance and with a large volume.

Other potential applications include attenuation of inertia and protection from mechanical impacts in any mass 8, such as vehicles (cars, airplanes, among others, or the system of FIG. 4.I, dwellings, habitations, doors, windows, or people dressed, covered or surrounded completely or partially by the conductor 1 (FIG. 5.O), which, may be rigid or flexible, uniform or segmented, and thick or thin (paint for example), and be optionally coated on the outside and/or inside by one or more dielectrics 3 (FIG. 5.D), where conductor 1 may optionally be internally coated also by material 6 (FIG. 5.E) or by any other material.

In addition to general use in flying vehicles carrying people or equipment, another possible civil or military application will be the generation of propulsion, and/or attenuation of inertia, and/or protection from mechanical impacts, in people fully or partially dressed in individualized suits of rigid or flexible conductor material 1 with a shape adapted to the human body, i.e., which follow the shape of the body, or with any other shape, using any of the propulsion units 7 or using uniform, i.e., one-piece, or segmented, i.e., several conductors 1 in close proximity to each other and electrically connected to each other or separated by dielectric 3 or any other material. By applying asymmetric electrical pulses to conductor 1, or several conductors 1, we can obtain a conductive human armor or garment with remarkable properties including propulsion, and/or inertia attenuation, and/or protective shielding. Even the possible visor on the head, or the visor of any vehicle for external observation, could be made of transparent conductive material and be subjected to the same asymmetric pulses. Propulsion may be selectively applied to specific parts of this metallic suit or conductive armor, such as on the palms of the hands and soles of the feet, or on the chest and back, among other places. The result would be similar to the flying armor depicted in the fictional movie “Iron Man”, but better given that the occupant of this armor could move very quickly and without inertia, with an electromagnetic rather than mechanical protective shield (or both together).

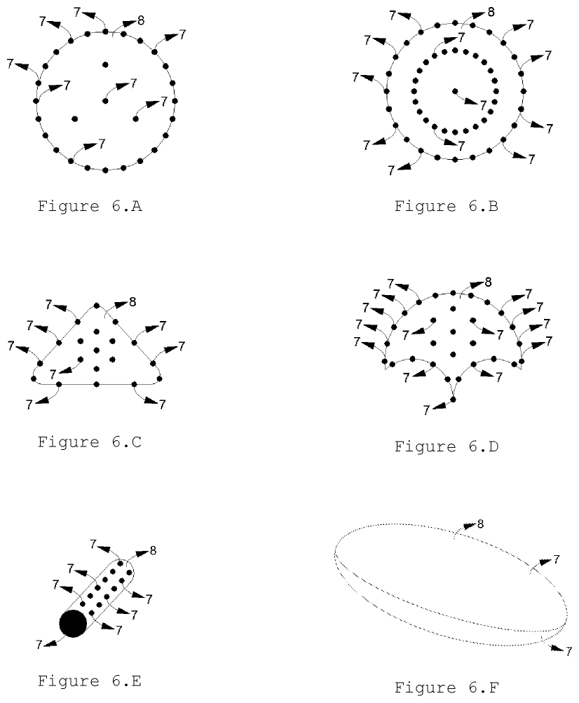

In order to illustrate some preferred and non-limiting applications of the previously discussed propulsion units 7 we now illustrate some concepts in FIG. 6. We can use a uniform distribution of propulsion units 7 around the periphery of the mass 8, in order to control the horizontal or vertical direction of the propulsion forces (FIGS. 6.A to 6.F). In these cases we also use several propulsion units 7 distributed in triangular (FIG. 6.A), or hexagonal (FIGS. 6.C and 6.D), or circular (FIGS. 6.B and 6.E) patterns along the top, bottom or side surfaces. Any uniform or non-uniform (random) pattern in the distribution of the propulsion units 7 may be used. Instead of using a few propulsion units at specific points on the mass or ship 8 that we want to move, we could make the entire ship or mass 8 a single propulsion unit (FIG. 6.F), using any of the propulsion units 7 shown in FIGS. 1.A to 1.M, 2.A to 2.G, 3.A to 3.Y, 4.A to 4.P and 5.A to 5.P, and the occupants can be protected from electromagnetic fields if they are inside a Faraday cage or metallic, and/or magnetic and/or dielectric envelope 6, or if the propulsion units 7 themselves are enveloped by the material 6 as discussed earlier. In case conductors 1 or 2 are on the outside of the mass 8, covered or not by dielectric 3, they will attenuate inertia and generate forces of repulsion or attraction on any external mass around them, including protective force fields and manipulation applications of any external object.

As illustrated, any desired shape for the personal metallic suit, or ship, or mass 8 may be used (FIG. 6.A to 6.F). The only important factor is the use of one or more propulsion units 7 in order to control the direction of propulsion, which can be at the periphery of the mass 8 or immersed in any position within it. Other variations to consider will be independent vertical, diagonal or horizontal parts of the ship, suit or mass 8 that may contain propulsion units 7 and be movable and tiltable in any direction. All the variations discussed can be applied to motorcycles, cars, flying skateboards, submarines, airplanes, spaceships, drones, flying platforms in any environment, hang gliders, back-mounted personal transportation systems of the jetpack-type (with or without a paraglider), or flying armor, with inertial dampening and protective shields similar to the fictional movie “Iron Man”, or flying motorcycles and cars, among many other related and unmentioned application possibilities.

1. Electromagnetic propulsion system, characterized by the use of a capacitor formed by a conductor (1) and a conductor (2), separated and wrapped completely by the dielectric (3), subjected to voltage pulses V or electric fields E with asymmetric temporal derivative, i.e. with the product E·∂E/∂t or V·∂V/∂t asymmetric, between conductors (1) and (2), where these asymmetric pulses can be applied to one or more capacitors, or to one or more propulsion units (7), and with any magnitude or repetition rate of the pulses, including the application of pulses of extreme magnitude.

2. Electromagnetic propulsion system, according to claim 1, characterized by the use of any number of conductors (1) and (2) in succession on the same capacitor, in which some or all of the conductors (1) and (2) may be connected to one or more power sources (5), and where one or more conductors (2) will be able to control the direction of the force produced by electrically feeding that conductor (2) used to the right or left of another conductor (1), where the conductors (1) and (2) can assume any electrical polarity.

3. Electromagnetic propulsion system according to claim 1, characterized by said conductors (1) and (2) may have any geometry or cross-section other than those specifically referred to, wherein as a non-limiting example, the conductors (1) and (2) may include disc, rectangular, simple triangular or pizza slice-like geometries, circular, cylindrical, oval, ellipsoidal, hemispherical convex, concave, partial or complete sections of spheres or of ellipses or of ovals, square, triangular, hexagonal and so on, solid, thin or hollow with a hole in the middle, such as toroids or rings, and any mixture thereof, wherein the geometries used in conductors (1) and (2) may be equal to each other and of equal or different relative size, and conductors (1) and (2) may also not be equal to each other in their geometry or size; wherein conductors (1) may be connected in series with other conductors (1) in any number, and conductors (2) may also be connected in series with other conductors (2) in any number, wherein the number of elements (1) and (2) in series in the same capacitor may be equal or different from each other; wherein a further possible variation includes part of the conductor (1) which may be extended or partially extended in a small tab or extension, or more than one extension, to the opposite surface of the dielectric (3) where the conductor (2) is, and/or reciprocally the conductor (2) optionally having one or more tabs or extensions to the surface where the conductor (1) is.

4. Electromagnetic propulsion system, according to claim 1, characterized by said conductors (1) and (2) can be placed close together in any distribution or grid, such as linear distributions in the vertical, or in the horizontal or circular in a 360° circle, where conductors (1) and (2), in the shape of pizza slices for example, lateral ones can be activated in isolation and independently or all can be activated simultaneously and interconnected, and these can be submitted to opposite or equal polarities in the same horizontal plane, being preferable the application of equal polarities, and where the cross section of the conductors (1) and (2) can be horizontally aligned or have variations in that horizontal alignment, being able the conductors (1) and (2) maintain or change its size and dimensions along its cross-section, using cylindrical, or conical, or angular, or any other 3D shapes.

5. Electromagnetic propulsion system, according to claim 1, characterized by the use of capacitors with a single conductor (1) for two or more conductors (2), separated by the dielectric (3), where both conductors (1) and (2) may be exposed to the outside environment without dielectric protection, or only the conductors (2) may be completely surrounded by the dielectric (3), or only the conductor (1) may be completely surrounded externally or internally by the dielectric (3), or both conductors (1) and (2) may be partially or completely involved by the dielectric or by the dielectrics (3); where we can use any number of conductors (2) together with one conductor (1), distributed randomly or in any pattern and geometry, such as non-limiting example using patterns of distribution of conductors (2) triangular, square, pentagonal, hexagonal, circular, rectangular, ellipsoidal, among others, with or without one or more conductors (2) placed in the center of this distribution; where the conductors (1) and (2) may have any geometric shape of their own according to claim (3), two-dimensional or three-dimensional, where in an additional and non-limiting way we can use conductors (1) flat or round in the form of a disk or flat two-dimensional ring or any spherical or curved three-dimensional shape such as circular, round, spherical, tubular, square, triangular, pentagonal, hexagonal or oval shapes, which may be made from a single conductor (1), or the same shape may be made with several independent sections of several conductors (1), in electrical contact with each other or separated by the dielectric (3), or separated by any other material, that is, the same shape can be segmented into two or more independent sections, separated or not by the dielectric (3) or by any other material; where we can use any number of conductors (2) distributed in any organization inside the conductor (1) and separated from it by the dielectric (3); where the conductors (2) can be used in the same way on the outside of the curved conductor (1), separated from each other as before by the dielectric (3) individually; where the dielectric (3) may involve only a limited area around the conductor (2) and/or the dielectric (3) may be distributed in a uniform, or non-uniform, layer completely inside and/or outside the conductor (1), and involving or accompanying or not dielectric (3) surrounding each conductor (2); where each of the conductors (2) and dielectrics (3) internal and/or external to the conductor (1) can be protected by the material (6) individually or globally; where we can use the dielectric (3) individually in conductors (1) or (2), or the dielectric (3), or several dielectrics (3), can be used globally involving all conductors (2), including also between the conductor (1) and the material (6); where the conductor (1) and the material (6) can be used reciprocally inside or outside each other; where the relative position of the conductor (2) between the conductor (1) and the material (6) can be calibrated or adjusted; where the external and/or internal side of the conductor (1), or of the material (6) if it is a conductor, may optionally be covered by any type of dielectric (3); where if the conductor (1) is a curved section corresponding to half of an oval or sphere or circle, the optional flat part on the right may be constituted by the conductor (1), or by the material (6), or by the dielectric (3), independently or simultaneously; where the dielectric (3) may optionally separate the curved conductor (1) from the flat conductor (1), or from the flat conductor (2), or from the flat material (6); and where the curved conductor (1), or the flat conductor (1) or (2), may optionally be coated internally and/or externally by the dielectric (3).

6. Electromagnetic propulsion system, according to claim 1, characterized by the use of only two or more conductors (1) external or close to the surface of a mass (8), which may constitute any number of conductive sections (1) independent, separated laterally by the dielectric (3), or separated by any other material; where the external conductors (1) can be coated externally and/or internally optionally by the dielectric (3); where a material (6) internal to the segmented conductors (1) can be optionally used to wrap any material; where the conductor (1), or the global form of the several conductors (1), may have several forms according to claims 3) and (5); where if the conductor (1) is a curved section corresponding to half of an oval or sphere or circle, the optional flat part on the right may be constituted by the conductor (1), or by the material (6), or by the dielectric (3), independently or simultaneously; where the dielectric (3) may optionally separate the curved conductor (1) from the flat conductor (1), or from the flat conductor (2), or from the flat material (6); and where the curved conductor (1), or the conductor (1) or (2) flat, may optionally be coated internally and/or externally by the dielectric (3); where the flat conductors (1) can be used as a propulsion unit (7) if they have dielectrics (3) with different relative electrical permittivity on opposite faces, where the different dielectrics (3) can partially or completely surround the conductor (1).

7. Electromagnetic propulsion system according to claim 1, characterized by the use of resistive or inductive switches (4), of the “spark gap” or “surface discharge” type or resistor with switch, or any other variety, in conjunction with one or more power supplies (5), which allow charging or discharging of conductors (1) and/or (2), using resistive switches (4) internal and/or external to the capacitor itself.

8. Electromagnetic propulsion system, according to claim 1, characterized by the use of propulsion units (7), with symmetrical or asymmetrical capacitors, where the dielectric (3) may be made of one or more materials, uniform or individually non-uniform, placed or used in such a way as to generate a relative electrical permittivity gradient along the dielectric (3) in a given direction, where a constant voltage and electric field is applied, or oscillating, or rectified oscillating, or asymmetrically pulsed to one or more propulsion units (7); where in this specific case, the conductors (1) and/or (2) of the capacitors will have to be completely encapsulated by the dielectric (3) when the capacitor is asymmetrical and constant or oscillating voltage is applied; and where when the capacitor is symmetrical or rectified oscillating voltages are applied, or pulsed asymmetrically to symmetrical or asymmetrical capacitors, the conductors (1) and/or (2) of the capacitors may be exposed to the atmosphere, or encapsulated by the dielectric (3) partially or completely.

9. Electromagnetic propulsion system, according to claim 1, characterized by the use of propulsion units (7), which can be surrounded or protected, totally or partially, by dielectric and/or conductive, and/or magnetic materials (6), where the material (6) may also involve any object of interest, including but not limited to, people, diverse biological material, or nearby equipment, inside or outside the conductors (1), and/or (2), and/or the propulsion units (7); or where the propulsion units (7) may be inserted inside a dielectric, conductive or magnetic protection or envelope (6), with the aim of protecting or maintaining a vacuum or gases suitable for its operation.

10. Electromagnetic propulsion system according to claim 1, characterized by the conductors (1) and (2) can be thick or thin like paint or thin film, or made of any conductive, superconducting or semiconducting material, or materials that generate superconductivity, with the possibility or option of painting their surface with any paint mixture of small conductive, or non-conducting, or semiconducting, or magnetic particles, or nanoparticles of carbon, graphene or any other material, with positive or negative permittivity or permeability.

11. Electromagnetic propulsion system, according to claim 1, characterized by the dielectric (3) may consist of any solid, liquid or gaseous material, and may have a positive or negative, linear or non-linear relative permittivity, or even be the vacuum itself or a gas at low or high pressure, where the dielectric (3) can be pure or be a symmetrical or asymmetrical mixture of several different dielectrics and may optionally contain embedded in its interior, symmetrically or asymmetrically, any number of small conductive, or semiconducting, or non-conducting, or magnetic particles, or nanoparticles of positive or negative, linear or non-linear, permittivity or permeability, such as powder, or metallic, or magnetic, or semiconducting, or other paint; where the dielectric (3) may include the use of piezoelectric materials, or pyroelectric materials, or ferroelectric materials, or metamaterials, or glasses, or quartz, or ceramics, or plastics, or any other type of dielectric; where the dielectric (3), and/or material (6), and/or conductors (1) or (2) may be metal matrix composite materials, and/or ceramic matrix composite materials, and/or matrix composite materials of carbon, and/or composite materials of polymer matrices, among many other possibilities; where the dielectric (3) may involve wholly or partially the conductors (1) and (2), being able to expose the conductors (1) and (2) to the surrounding gas or atmosphere or environment preferably when the voltage used in the conductors (1) and (2) is not sufficient for the ionization of this gas.

12. Electromagnetic propulsion system, according to claim 1, characterized by the use of one or more power supplies (5), of high or low voltage or current, constant, oscillating, rectified oscillating, pulsed or any other, including asymmetric pulses or pulses with asymmetric time derivative of voltage V or electric field E, with product E·∂E/∂t or V·∂V/∂t asymmetric, such as Marx generators, inductive voltage pulse generators, microwave generators with asymmetric voltage pulses, among many other options, used together or not with the resistive switches (4), and using any magnitude or repetition rate of the applied voltage pulses, connected to one or more conductors (1), and/or (2), and/or material (6), in any configuration.

13. Electromagnetic propulsion system according to claim 1, characterized by the use independently or in conjunction, of any of the propulsion units (7) attached to a mass (8) or to part of such mass (8), which has any shape, and distributed along its periphery, or in any other desired position, inside or outside the mass (8), in any number, pattern, or arrangement, wherein we may also make the ship, suit, or mass (8) itself a single propulsion unit, using any of the propulsion units (7), and the mass (8) may have independent vertical, diagonal, or horizontal parts, which may contain propulsion units (7), which may be movable and inclinable in any direction.

14. Propulsion system, and/or inertia attenuator, and/or force field generator, characterized by the use of any of the propulsion units (7), or by a single conductor (1) whole or segmented, with arbitrary shape, placed on the surface or outside or around the mass (8), partially or completely, where one or more external conductors of that propulsion unit (7) or the entire or segmented conductor (1) is connected to one or more power supplies (5); where the mass (8) may be, in a non-limiting way, any flying, or terrestrial, or underwater, or space vehicle, among others, or simply be any dwelling, cabin, door, window, among other possibilities; where the mass (8) may be a person completely or partially dressed, coated or surrounded with individualized suits containing propulsion units (7) or containing a conductive material (1) rigid or flexible, with a shape adapted to the human body, that is, that follows the shape of the body, or with any other form, using any of the propulsion units (7) or using external conductors (1) uniform, that is, of a single piece, or segmented, that is, several conductors (1) in close proximity and electrically connected to each other or separated by the dielectric (3) or any other material, where propulsion or a force field may be selectively applied to specific parts of this metallic suit or conductive armor depending on which conductor (1) or propulsion unit (7) is electrically activated with asymmetrical electrical pulses, as described in claim (13); where the conductor (1) may be rigid or flexible, opaque or transparent, uniform or segmented, and thick or thin, like paint for example; where the conductor (1) may optionally be coated outside and/or inside by one or more dielectrics (3), flexible or rigid; where the conductor (1) may optionally be coated internally also by the material (6) or by any other material, flexible or rigid; where any mass (8) completely or partially surrounded by the propulsion units (7), or by a single conductor (1), or by several conductors (1), connected to one or more power supplies (5), will have its inertia attenuated, where the propulsion system is as defined in claims (1) to (13).
